(19) United States
(12) Patent Application Publication
(10) Pub. No.: US 2026/0239296 A1
(43) Pub. Date: Aug. 13, 2026

(54) METHOD AND APPARATUS FOR TRANSMITTING A SCHEDULING REQUEST BASED ON A CONDITION

(71) Applicant: InterDigital Patent Holdings, Inc., Wilmington, DE (US)

(72) Inventors: Martino FREDA, Laval (CA); Tuong HOANG, Montreal (CA); Oumer TEYEB, Montreal (CA); Ananth KINI, Conshohocken, PA (US)

(73) Assignee: InterDigital Patent Holdings, Inc., Wilmington, DE (US)

(21) Appl. No.: 19/154,674

(22) PCT Filed: Feb. 14, 2024
(86) PCT No.: PCT/US2024/015815

§ 371 Date: Aug. 7, 2025

Related U.S. Application Data
(60) Provisional application No. 63/445,602, filed on Feb. 14, 2023.

(51) Int. Cl. H04W 72/02; H04W 72/25

(52) U.S. Cl. CPC H04W 72/02; H04W 72/25

(57) ABSTRACT

A wireless transmit/receive unit (WTRU) and methods implemented therein are described. A method, implemented in a WTRU configured in multipath with mode 2 on sidelink and at least one flexible radio bearer configured with both a Uu logical channel and an SL logical channel, includes receiving a configuration for a dedicated Uu scheduling request (SR) related to a condition associated with mode 2 resource selection. The WTRU transmits the dedicated Uu SR based on the condition being met.

### CROSS-REFERENCE TO RELATED APPLICATIONS

This application claims the benefit of U.S. Provisional Application No. 63/445,602, filed Feb. 14, 2023, the contents of which are incorporated herein by reference.

### SUMMARY

A wireless transmit/receive unit (WTRU) and methods implemented therein are described. A method, implemented in a WTRU configured in multipath with mode 2 on sidelink and at least one flexible radio bearer configured with both a Uu logical channel and an SL logical channel, includes receiving a configuration for a dedicated Uu scheduling request (SR) related to a condition associated with mode 2 resource selection. The WTRU transmits the dedicated Uu SR based on the condition being met.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of a user plane protocol stack for layer 2 (L2) for a WTRU-to-Network relay;

FIG. 3 is a diagram of a control plane protocol stack for L2 for a WTRU-to-Network relay;

FIG. 4 is a diagram of a protocol view of a split bearer for dual connectivity (DC);

FIG. 5 is a diagram of a protocol stack for carrier aggregation (CA);

FIG. 6 is a diagram of an example protocol stack for multipath. Use of the carrier aggregation model directly to multipath may have some issues; and

FIG. 7 is a flow diagram 700 of an example method of triggering a dedicated SR based on a result of an event on SL, implemented in a WTRU.

### DETAILED DESCRIPTION

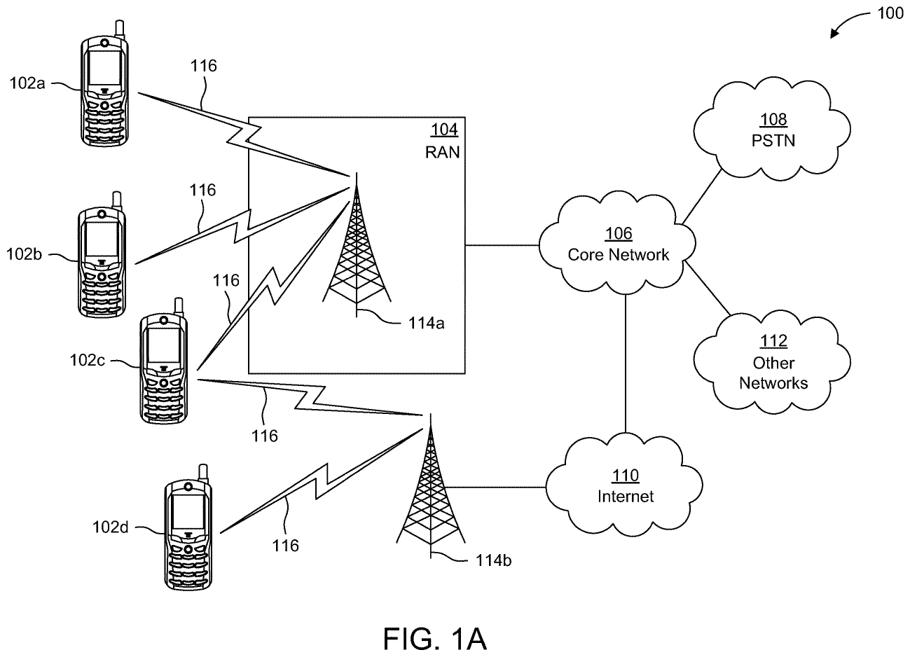

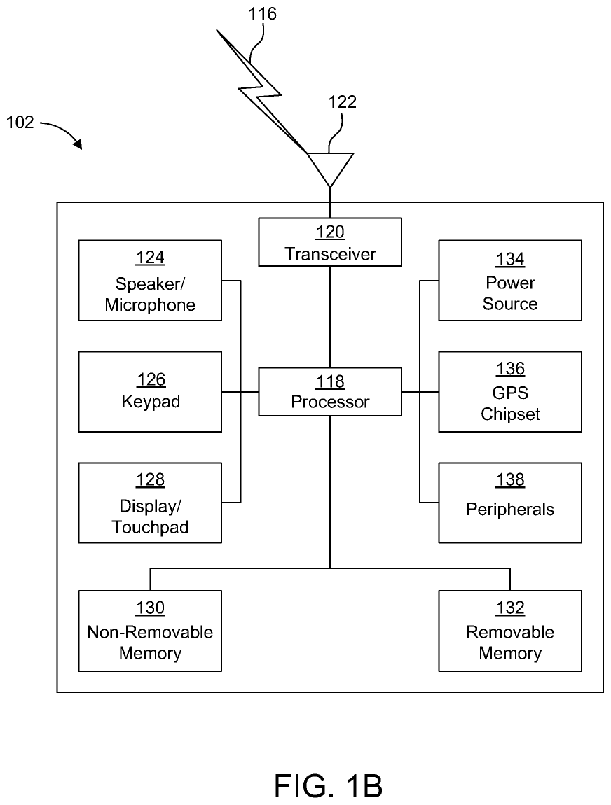

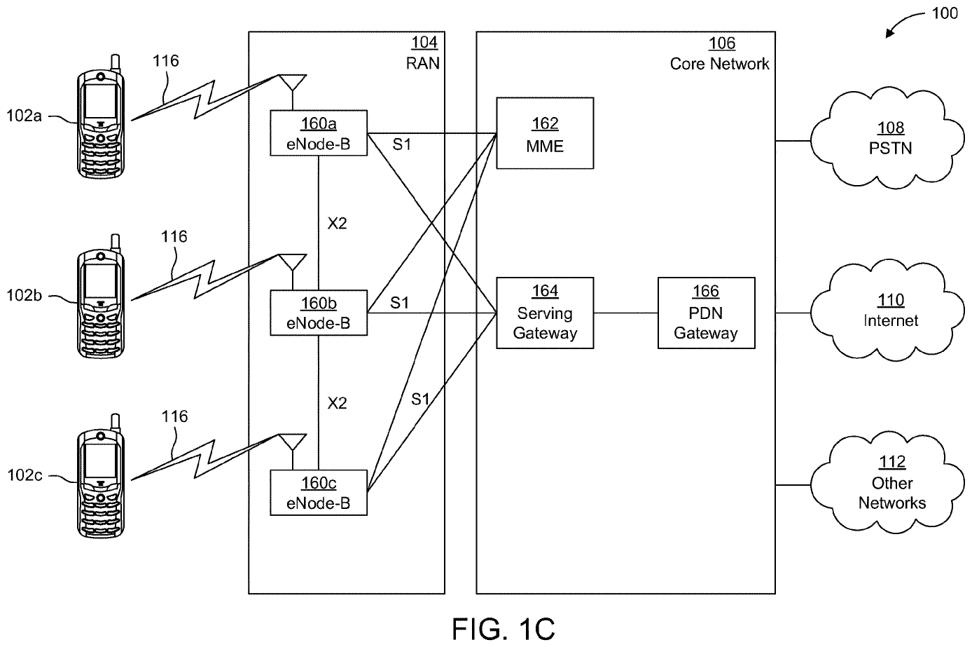

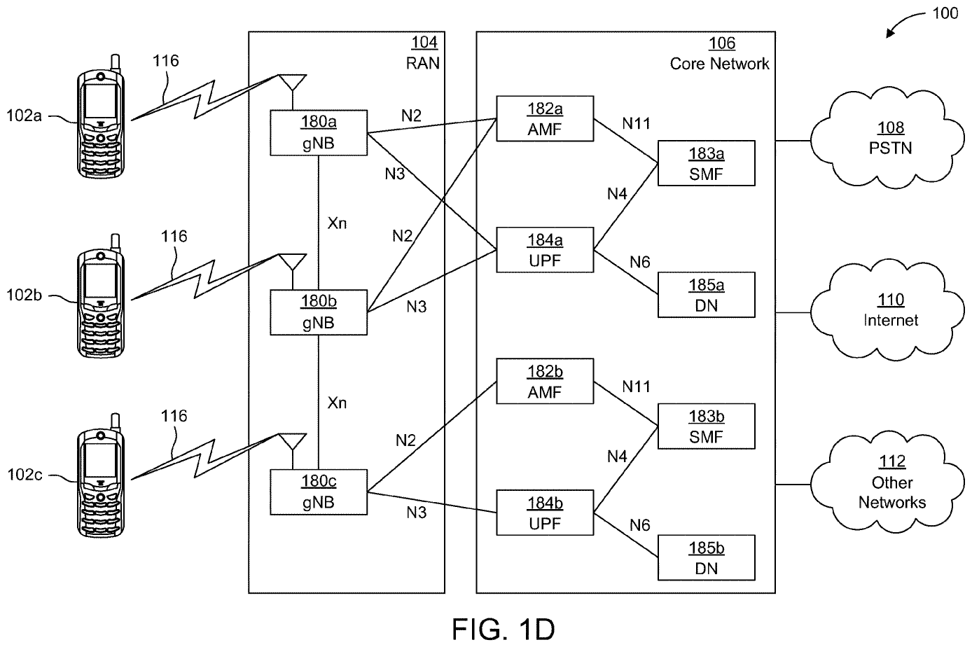

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

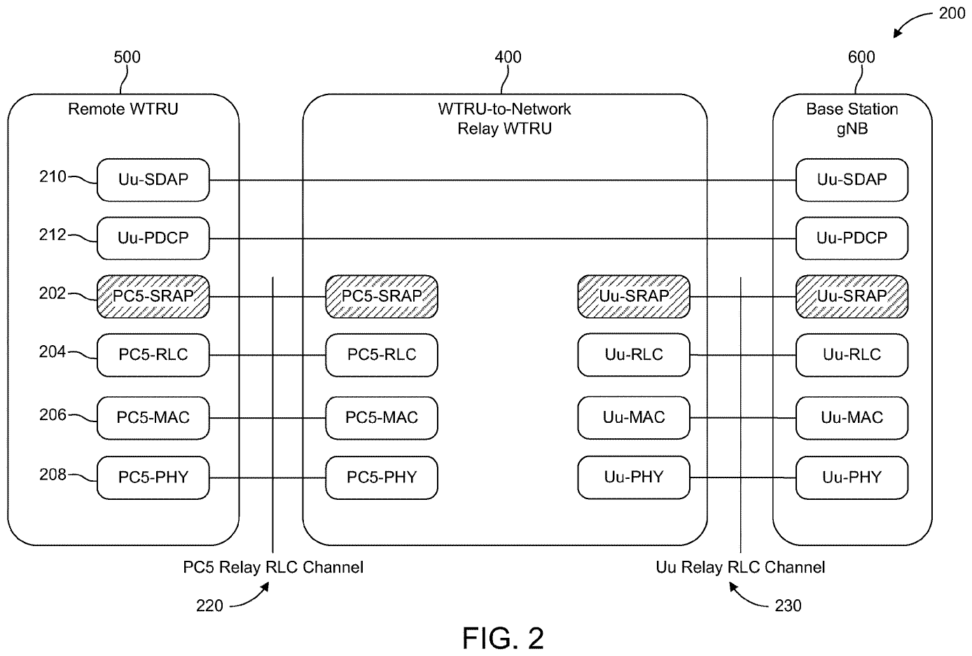

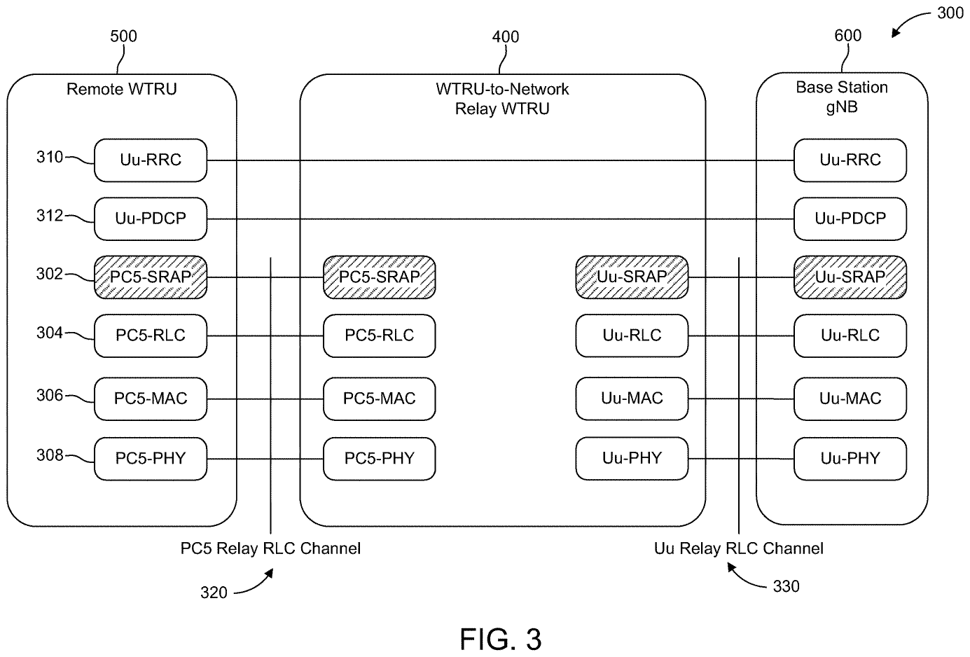

FIG. 2 is a diagram of a user plane protocol stack 200 for layer 2 (L2) for a WTRU-to-Network relay 400. FIG. 3 is a diagram of a control plane protocol stack 300 for L2 for the WTRU-to-Network relay 400. In the examples illustrated in FIGS. 2 and 3, for both the user plane 200 and the control plane 300, the Sidelink Relay Adaptation Protocol (SRAP) sublayer 202, 304 is above the Radio Link Control (RLC) sublayer 204, 304 for both at both the PC5 interface 220 and the Uu interface 230. The Uu Service Data Adaptation Protocol (SDAP) 210, Packet Data Convergence Protocol (PDCP) 212, 312 and Radio Resource Control (RRC) 310 may be terminated between the L2 U2N Remote WTRU 500 and the base station 600 (e.g., gNB), while the SRAP 202, 302, RLC 204, 304, MAC 206, 306 and physical layer (PHY) 208, 308 may be terminated in each hop, using a link between the L2 U2N Remote WTRU 500 and the L2 U2N Relay WTRU 400 and a link between the L2 U2N Relay 400 WTRU and the base station 600.

For the L2 U2N Relay 400, the SRAP sublayer 202 over the PC5 hop 220 is only for the purpose of bearer mapping. The SRAP sublayer 302 is not present over the PC5 hop 320 for relaying messages from the L2 U2N Remote WTRU 500 on the Broadcast Control Channel (BCCH) and the Paging Control Channel (PCCH). For messages from the L2 U2N Remote WTRU′ 500 on SRB0, the SRAP header is not present over the PC5 hop 220, but the SRAP header is present over the Uu hop 230 for both DL and UL.

A sidelink (SL) WTRU may be configured to operate in either mode 1 or mode 2. In mode 1, the WTRU may be scheduled on sidelink by the network, for example using Downlink Control Information (DCI) scheduling for sidelink grants. In mode 2, the WTRU may perform resource selection and/or re-selection to schedule sidelink resources.

Mode 2 resource selection may be further characterized by the potential use of sensing. A WTRU that supports sensing can use the results of sensing, or the indication of Sidelink Control Information (SCI) transmissions over a period of time that are forward booking resources, to select a set of resources for transmission. Resource selection may include determining a set of available resources based on these sensing results and comparing the observed SCIs' Reference Signal Received Power (RSRP) with a threshold that is dependent on the priority of the transmission to be made during the sensing and the transmission announced by the other SCI. If a certain percentage of resources is deemed available, a WTRU can randomly select resources, either for a single transmission, or for multiple periodic transmissions announced by a forward booking indication in the SCI, to be used for transmission. When insufficient resources are available to perform random selection, the WTRU may increase its threshold for availability by, for example, 3 dB until the sufficient amount of resources is deemed as available.

Mode 2 resource selection may be further limited by congestion control. In Mode 2, the WTRU may measure the channel busy ratio (CBR). The WTRU may be configured with some limitations in transmission based on the CBR, such as a maximum number of retransmissions, a Modulation and Coding Scheme (MCS), and/or a maximum number of subchannels, to avoid congestion being further increased when it is high. Congestion parameters may be further conditioned on the priority of a transmission such that high priority transmissions may suffer less from congestion control limitations.

The enhancements to the NR SL relay may be continued in Release 18. One of the features that may be included in discussion is the support of multi-path with relay, where a remote WTRU may be connected to the network via direct and indirect paths, which may have the potential to improve the reliability/robustness as well as throughput. Such multi-path relay may also be utilized for WTRU aggregation where a WTRU may be connected to the network via a direct path and via another WTRU using a non-standardized WTRU-WTRU interconnection. WTRU aggregation may provide applications requiring high UL bitrates on 5G terminals in cases when normal WTRUs are too limited by UL WTRU transmission power to achieve a required bitrate, especially at the edge of a cell. Additionally, WTRU aggregation can improve the reliability and stability of services, as well reducing their delay. In such situations, if the channel condition of a terminal is deteriorating, another terminal can be used to make up for the traffic performance unsteadiness caused by channel condition variation.

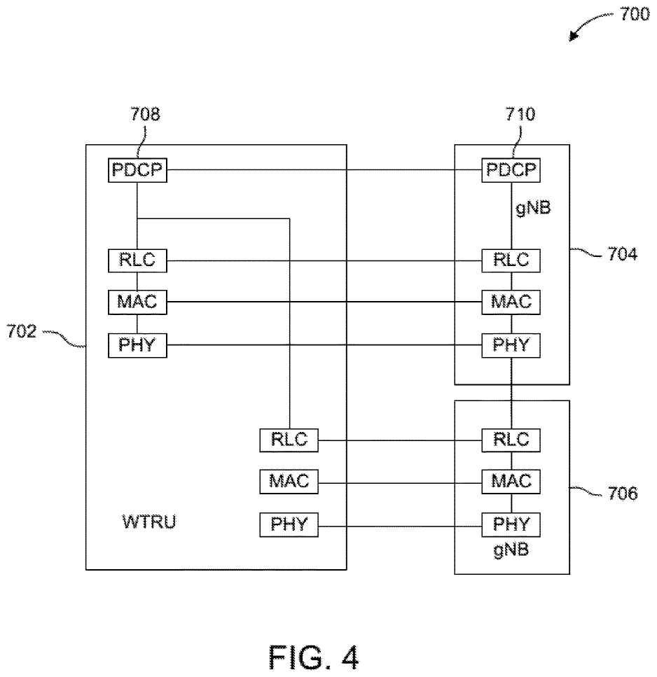

FIG. 4 is a diagram of a protocol view of a split bearer 700 for dual connectivity (DC). In DC, a WTRU 702 may be served by two nodes 704 and 706, each including a set of cells known as a Master Cell Group (MCG) and a Secondary Cell Group (SCG). A bearer can be associated with only the MCG or SCG, or can be configured as a split bearer, as shown in FIG. 4, for example.

Like any bearer, and as in the example illustrated in FIG. 4, the WTRU 702 will have one PDCP entity 708 associated with it. On the network side, the peer PDCP entity 710 is terminated at one of the gNBs (704 in FIG. 4), which may be either the master or the secondary. In the DL, the CN may send data to the gNB 704 where the PDCP is terminated, and it may be up to the network to directly send the data to the WTRU 708 via the link between the gNB 704 and the WTRU 702 or to forward the PDCP PDUs to the gNB 706, such as via an Xn interface). The gNB will send the data to the WTRU via the link between itself and the WTRU.

In the UL, the WTRU 702 may be configured with one of the paths as the primary path and the other as a secondary path. A threshold, commonly referred to as UL split buffer threshold, may also be configured. If the UL buffer size for that bearer is less this threshold, the PDCP 708 will push the data only to the RLC associated with the primary path. However, if the buffer size becomes larger than the threshold, then the WTRU can push the data to either path (e.g., left to WTRU 500 as illustrated in FIG. 3, for example).

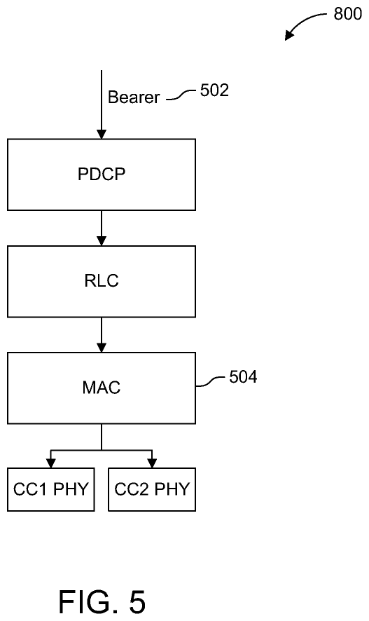

FIG. 5 is a diagram of a protocol stack 800 for carrier aggregation (CA). In CA, data in a bearer 502 can be transmitted in any carrier. A logical channel at the MAC layer 504 can send data on any of the two carriers in a flexible manner to either carrier or can be configured with a duplicate logical channel to allow CA duplication with carrier restriction.

Triggers for Uu and SL buffer status reporting (BSR) may be similar to each other. For example, a BSR may be triggered if any of the following events occur for an activated cell group: (1) uplink data for a logical channel that belongs to a logical channel group (LCG) becomes available to the MAC entity 504 and either (a) the UL data belongs to a logical channel with higher priority than the priority of any logical channel containing available UL data that belong to any LCG or (b) none of the logical channels that belong to an LCG contains any available UL data, in which case, the BSR may be referred to herein a as regular BSR; (2) UL resources are allocated and the number of padding bits is equal to or greater than the size of the BSR MAC Control Element (CE) plus its subheader, in which case the BSR may be referred to herein as a padding BSR; and/or (3) the periodicBSR-Timer expires, in which case the BSR may be referred to herein as a periodic BSR. When regular BSR triggering events occur for multiple logical channels simultaneously, each logical channel may trigger one separate regular BSR.

A WTRU may trigger resource selection and/or re-selection in mode 2 based on the following. If the transmit (TX) resource selection and/or re-selection check procedure is triggered on the selected pool of resources for a sidelink process, the MAC entity may, for the sidelink process: (1) if the Physical Sidelink Control Channel (PSSCH) and second stage SCI on the PSSCH for all transmissions of a MAC PDU of any selected sidelink grant or grants are not in SL discontinuous reception (DRX) active time of the destination that has data to be sent; or (2) if SL_RESOURCE_RESELECTION_COUNTER=0 and when SL_RESOURCE_RESELECTION_COUNTER was equal to 1 the MAC entity randomly selected, with equal probability, a value in the interval [0, 1] that is above the probability configured by RRC in s/-ProbResourceKeep; or if the pool of resources is configured or reconfigured by RRC; or (3) if there is no selected sidelink grant on the selected pool of resources; or if neither transmission or retransmission has been performed by the MAC entity on any resource indicated in the selected sidelink grant during the last second; or (4) if s/-ReselectAfter is configured and the number of consecutive unused transmission opportunities on resources indicated in the selected sidelink grant, which is incremented by 1 when none of the resources of the selected sidelink grant within a resource reservation interval is used, is equal to s/-ReselectAfter, or (5) if the selected sidelink grant cannot accommodate a RLC SDU by using the maximum allowed MCS configured by RRC in s/-MaxMCS-PSSCH associated with the selected MCS table and the WTRU selects not to segment the RLC SDU; or (6) if transmission(s) with the selected sidelink grant cannot fulfil the remaining PDB of the data in a logical channel, and the MAC entity selects not to perform transmission(s) corresponding to a single MAC PDU: clear the selected sidelink grant associated to the Sidelink process if available and trigger the TX resource selection or re-selection. If the selected sidelink grant in (5) cannot accommodate the RLC SDU, it may be left for WTRU implementation whether to perform segmentation or sidelink resource reselection. If in (6) the remaining PDB is not met, it may be left for WTRU whether to perform one or more transmissions corresponding to a single MAC PDU or sidelink resource selection. It may be left for WTRU implementation whether to trigger the TX resource selection or re-selection due to the latency requirement of the triggered MAC CE, for example.

A possible configuration for a WTRU in multipath is for the WTRU to perform SL transmission to the relay WTRU while configured in mode 2. In such case, the WTRU may be scheduled by the network on Uu, but may perform its own scheduling on the sidelink. For the bearers of the WTRU, it is clear for bearers that are configured on the Uu path or the SL path only whether the WTRU should report BSR to the network. However, what may not be clear is how to handle SR/BSR reporting for data associated with flexible bearers, specifically regarding how much data is reported in the Uu BSR to the network, and consequently, how the triggers for Uu SR/BSR may interact with the WTRU's self-scheduling of these bearers on SL in mode 2.

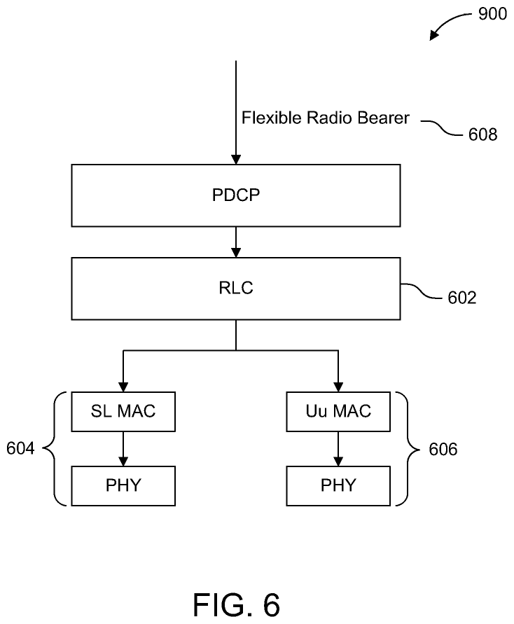

In DC, the PDCP may decide whether to push data in the MCG or SCG purely based on buffer status, and it may be up to the WTRU implementation to determine how much data to push to which RLC channel. In multipath for a remote WTRU, it may be desirable to allow a more flexible approach where data could be flexibly routed to either path depending on availability of grants (similar to carrier aggregation). Use of the carrier aggregation model directly for multipath, however, may present some issues. Specifically, it may be difficult to define a logical channel where data available for such logical channel can be flexibly transmitted to either the SL (relayed) path or the Uu (direct path) since a logical channel in Uu and a logical channel on sidelink may have very different configurations in RRC. Instead, the protocol stack for multipath assuming a more flexible (CA-based) scheduling can use an architecture such as shown in FIG. 6.

FIG. 6 is a diagram of an example protocol stack 900 for multipath. In the example illustrated in FIG. 6, a single RLC entity 602 that can flexibly send data via either the SL path or Uu path is configured with two separate logical channels 604 and 606. The SL logical channel 604 may be used for data transmissions via the indirect path, and the Uu logical channel 606 may be used for data transmissions via the direct path. The Uu logical channel 606 can be configured or behave like legacy Uu logical channels, while the SL logical channel 604 can be configured and behave like SL logical channels. Duplication can also be supported by having the RLC entity 602 transmit a PDU to both paths and both logical channels to transmit the data on their respective interface (Uu and SL). In the embodiments described herein, the following terminology may be used, considering that a split DRB mapped to the architecture illustrated in FIG. 6 may actually include two separate logical channels, which is not the case for carrier aggregation where a single logical channel is assumed. Uu RBS (e.g., for stringent latency) may be configured to transmit data via the Uu. Sidelink RBs (e.g., for long latency data) may be configured to transmit data via sidelink. Flexible RBs, such that the flexible RB 608 in FIG. 6 (e.g., for medium latency data and high reliability), may be configured to transmit data via either the Uu or sidelink based on certain conditions.

Embodiments described herein are assumed to apply predominately to flexible radio bearers, such as illustrated in FIG. 6, since they can dynamically send data over either path without the need for RRC reconfiguration. However, without loss of generality, the embodiments could be applied to Uu RBs and sidelink RBs as well.

A WTRU may be configured with a dedicated SR resource and may trigger such an SR upon a condition associated with mode 2 resource selection. A WTRU configured in multipath with mode 2 on SL and with at least one radio bearer that can be transmitted on both paths may receive a configuration for a dedicated SR related to a condition associated with mode 2 resource allocation. Such receiving may be or include one or more of: triggering pre-emption for a periodic reserved resource allowing transmissions from the at least one bearer, receiving a conflict indication from a peer WTRU associated with a periodic resource allowing transmissions from the at least one bearer, experiencing SL RLF and/or receiving an SL WTRU indication from the peer WTRU (e.g., a HO). Upon the condition being met, the WTRU may transmit the dedicated Uu SR.

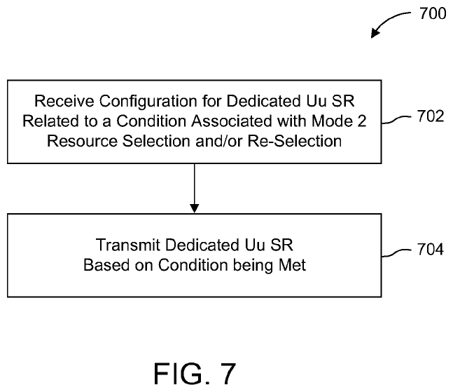

FIG. 7 is a flow diagram 700 of an example method of triggering a dedicated SR based on a result of an event on SL, implemented in a WTRU. The method may be configured in multipath with mode 2 on sidelink (SL) and at least one flexible radio bearer configured with both a Uu logical channel and a SL logical channel. In the example illustrated in FIG. 7, the WTRU may receive a configuration for a dedicated Uu SR related to a condition associated with mode 2 resource selection and/or re-selection (702). Based on the condition being met, the WTRU may transmit the dedicated Uu SR (704). Examples of receiving the configuration are described in the paragraph above and elaborated on in more detail below.

In some embodiments, a WTRU may perform a dedicated transmission to the network as a result of an event on the SL, such as when the WTRU is configured in multipath and/or when the WTRU has a flexible bearer. Such a message may be, for example, an SR, a PUCCH transmission, a RACH, a MAC CE, or an RRC message. In the embodiments described herein, a dedicated SR is assumed. However, aspects may apply to any other message.

In some embodiments, a WTRU may be configured with one or more dedicated SR resource for indicating an SL event to the network while in multipath. Alternatively, the WTRU may be configured to use one of the existing/configured SR resources (e.g., SR for the highest priority Uu LCH, SR for SL CSI reporting, etc.). In some embodiments, a WTRU may be configured with a single dedicated SR resource and may be configured with a condition for triggering SR, whereby any conditions described herein may be used. For example, the WTRU may trigger a dedicated SR if it determines a pre-emption for a periodic reserved resource allowing transmissions for at least one of the flexible bearers. For another example, the WTRU may trigger a dedicated SR if it receives a conflict indication from a peer WTRU associated with a periodic resource allowing transmissions from at least one flexible bearer. For another example, the WTRU may trigger a dedicated SR if it determines SL-RLF with the relay WTRU. For yet another example, the WTRU may trigger a dedicated SR if it receives a message from the peer WTRU (e.g., NotificationMessageSidelink) indicating, for example, a HO of the relay WTRU, Uu RLF of the relay WTRU, etc. In some embodiments, a WTRU may be configured with multiple dedicated SR resources and may select the SR resource based on the condition evaluated. For example, the WTRU may trigger a first SR under a first condition (e.g., flow control issue) and a second SR under a second condition (e.g., SL RLF). For example, the WTRU may trigger different SRs corresponding to different levels of the issue on SL or a different amount of data required on Uu to compensate for the issue on SL. For example, the WTRU may trigger a first SR if the CBR changes by a first amount and a second SR if the CBR changes by a second amount. For example, the WTRU may trigger a first SR if it decides to change the data split by a first amount and a second SR if it decides to change the data split by a second amount.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, implemented in a wireless transmit/receive unit (WTRU) in mode 2 and configured with a flexible radio bearer configured with a Uu logical channel and a sidelink (SL) logical channel, the method comprising:
receiving a configuration for a dedicated Uu scheduling request (SR) related to a condition associated with mode 2 resource selection; and
transmitting the dedicated Uu SR based on the condition being met.

2. The method of claim 1, wherein the configuration is a trigger for pre-emption for a periodic reserved resource allowing transmissions from the flexible radio bearer.

3. The method of claim 1, wherein the receiving the configuration comprises receiving a conflict indication from a peer WTRU associated with a periodic resource allowing transmissions from the flexible radio bearer.

4. The method of claim 1, wherein the receiving the configuration comprises experiencing SL radio link failure (RLF).

5. The method of claim 1, wherein the receiving the configuration comprises receiving an SL WTRU indication from a peer WTRU.

6. The method of claim 5, wherein the SL WTRU indication is a handover (HO) indication.

7. The method of claim 1, wherein the WTRU is configured with one or more dedicated SR resources for the WTRU to use for indicating an SL event while in multipath.

8. The method of claim 1, wherein the WTRU is configured with a single, dedicated SR resource and the condition for triggering SR.

9. The method of claim 1, wherein the WTRU is configured with multiple dedicated SR resources, and the method further comprises selecting an SR resource based on the condition.

10. The WTRU of claim 9, wherein the condition comprises at least two conditions, and the method further comprises sending a first SR under a first condition and a second SR under a second condition.

11. A wireless transmit/receive unit (WTRU) in mode 2 and configured with a flexible radio bearer configured with a Uu logical channel and a sidelink (SL) logical channel, the WTRU comprising:
a transceiver; and
a processor,
wherein the transceiver and the processor are configured to receive a configuration for a dedicated Uu scheduling request (SR) related to a condition associated with mode 2 resource selection, and
transmit the dedicated Uu SR based on the condition being met.

12. The WTRU of claim 11, wherein the configuration is a trigger for pre-emption for a periodic reserved resource allowing transmissions from the flexible radio bearer.

13. The WTRU of claim 11, wherein the processor and the transceiver are further configured to receive the configuration by receiving a conflict indication from a peer WTRU associated with a periodic resource allowing transmissions from the flexible radio bearer.

14. The WTRU of claim 11, wherein the configuration comprises experiencing SL radio link failure (RLF).

15. The WTRU of claim 11, wherein the processor and the transceiver are further configured to receive the configuration by receiving an SL WTRU indication from a peer WTRU.

16. The WTRU of claim 15, wherein the SL WTRU indication is a handover (HO) indication.

17. The WTRU of claim 11, wherein the WTRU is configured with one or more dedicated SR resources for the WTRU to use for indicating an SL event while in multipath.

18. The WTRU of claim 11, wherein the WTRU is configured with a single, dedicated SR resource and the condition for triggering SR.

19. The WTRU of claim 11, wherein the WTRU is configured with multiple dedicated SR resources, and the processor and the transceiver are further configured to select an SR resource based on the condition.

20. The WTRU of claim 19, wherein the condition comprises at least two conditions, and the processor and the transceiver are further configured to send a first SR under a first condition and a second SR under a second condition.
